(19) United States
(12) Patent Application Publication
(10) Pub. No.: US 2024/0341916 A1
(43) Pub. Date: Oct. 17, 2024

(54) DENTAL DRILL

(71) Applicant: KING FAISAL UNIVERSITY, AL-AHSA (SA)

(72) Inventors: NAZARGI MAHABOB, AL-AHSA (SA); ANIL BANGALORE SHIVAPPA, AL-AHSA (SA)

(21) Appl. No.: 18/133,279

(22) Filed: Apr. 11, 2023

(51) Int. Cl. A61C 1/05; A61C 1/00

(52) U.S. Cl. CPC A61C 1/055; A61C 1/0061

(57) ABSTRACT

The dental drill includes a handpiece having a head and a gripping portion, with a socket located within the head. A drill bit is received by the socket. An irrigation channel is formed through the drill bit and is in fluid communication with a plurality of openings formed through the first end of the drill bit. A suction channel is formed through the drill bit and is in fluid communication with a plurality of apertures formed through a shaft of the drill bit. An irrigation conduit connects the irrigation channel to a supply of water, and a suction conduit connects the suction channel to a vacuum source. The socket and drill bit are selectively driven to rotate by a motor or the like.

### BACKGROUND OF THE INVENTION

### Field of the Invention

The disclosure of the present patent application relates to dental tools, and particularly to a dental drill, such as those used for drilling bone during dental implantation procedures, with integrated irrigation and suction functionality.

### Description of Related Art

Dental drills, such as those used for drilling bone during dental implantation procedures, are common dental tools found in the offices of most dentists and oral surgeons. Whether being used to drill teeth or bone, the drilling procedure produces debris in the patient's mouth which must be washed out. The dentist or oral surgeon typically uses a spraying device to spray water into the patient's mouth and then uses a separate suction device to remove the water and the debris. Using the drill, the spraying device and the suction device together can be unwieldy for the dentist or oral surgeon and can also be uncomfortable for the patient. Additionally, due to continuous friction during use, the drill bit of the dental drill becomes hot, which can not only be dangerous to the patient but can also deform the shape of the drill bit. Thus, a dental drill solving the aforementioned problems is desired.

### SUMMARY OF THE INVENTION

The dental drill is similar to conventional dental drills, such as those used for drilling bone during dental implantation procedures, as a non-limiting example, but also includes integrated irrigation and suction functionality, thereby representing a significant improvement over conventional dental drills. The dental drill includes a handpiece having a head and a gripping portion, with a socket located within the head of the handpiece. A drill bit is provided, such that the drill bit has opposed first and second ends, with the second end thereof being received by the socket and the first end thereof being positioned external to the handpiece. An irrigation channel is formed through the drill bit, such that the irrigation channel is in fluid communication with a plurality of openings formed through the first end of the drill bit. A suction channel is also formed through the drill bit, such that the suction channel is in fluid communication with a plurality of apertures formed through a shaft of the drill bit.

An irrigation conduit connects the irrigation channel to a supply of water such that the water is selectively expelled through the plurality of openings formed through the first end of the drill bit. A suction conduit connects the suction channel to a vacuum source such that fluid and debris are selectively collected through the plurality of apertures formed through the shaft of the drill bit. The socket and drill bit are selectively driven to rotate in a conventional manner, such as by a conventional motor or the like coupled to the socket, as is well-known in the field of dental drills.

These and other features of the present subject matter will become readily apparent upon further review of the following specification.

### BRIEF DESCRIPTION OF DRAWINGS

FIG. 1 diagrammatically illustrates a dental drill.

FIG. 2 diagrammatically illustrates an upper portion of the dental drill, including a drill bit thereof.

Similar reference characters denote corresponding features consistently throughout the attached drawings.

### DETAILED DESCRIPTION

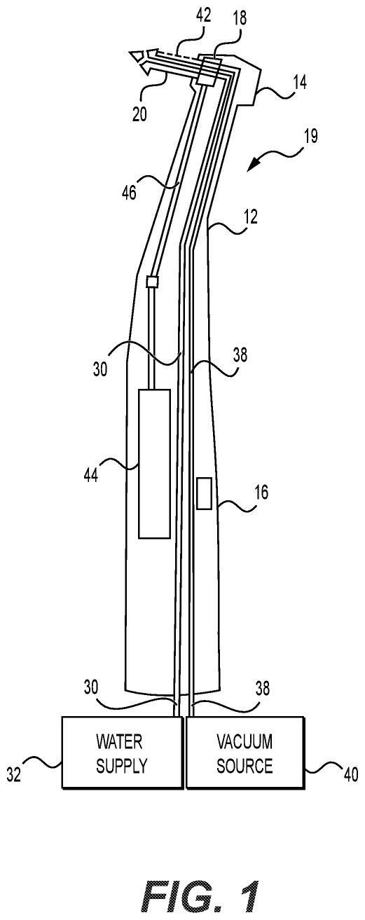

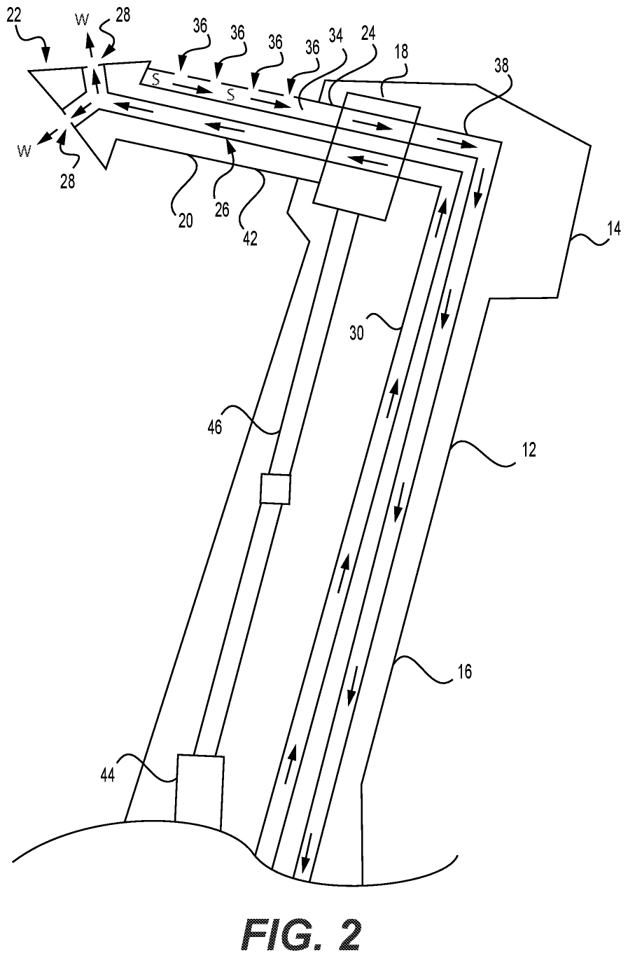

As shown in FIGS. 1 and 2, the dental drill 10 is similar to conventional dental drills, such as those used for drilling bone during dental implantation procedures, as a non-limiting example, but also includes integrated irrigation and suction functionality. The dental drill 19 includes a handpiece 12 having a head 14 and a gripping portion 16, with a socket 18 located within the head 14 of the handpiece 12. A drill bit 20 is provided, such that the drill bit 20 has opposed first and second ends 22, 24, respectively, with the second end 24 being received by the socket 18 and the first end 22 being positioned external to the handpiece 12. It should be understood that any suitable type of socket may be used for receiving and releasably holding drill bit 20, as is well-known in the field of dental drills. Further, it should be understood that the overall shape and relative dimensions of handpiece 12, as well as the relative locations and orientations of socket 18 and drill bit 20, are shown for exemplary purposes only.

As best seen in the enlarged view of FIG. 2, an irrigation channel 26 is formed through the drill bit 20, such that the irrigation channel 26 is in fluid communication with a plurality of openings 28 formed through the first end of the drill bit 20. A suction channel 34 is also formed through the drill bit 20, such that the suction channel 34 is in fluid communication with a plurality of apertures 36 formed through a shaft 42 of the drill bit 20. In the non-limiting example of FIG. 2, the irrigation channel 26 is shown being positioned along the rotational axis of the drill bit 20, however, it should be understood that irrigation channel 26 may have any suitable orientation and location with respect to drill bit 20. Further, suction channel 34 is shown as extending parallel to the rotational axis of drill bit 20, with suction channel 34 being positioned just beneath the surface of shaft 42, however, it should be understood that suction channel 34 may have any suitable orientation and location with respect to drill bit 20. Further, the first end 22 of drill bit 20 defines a drilling head, which is shown in the non-limiting examples of FIGS. 1 and 2 as having a substantially conical shape. However, it should be understood that the particular shape and relative dimensions of the drilling head defined by first end 22 are shown for exemplary purposes only. Similarly, it should be understood that the overall shape and relative dimensions of drill bit 20 are shown for exemplary purposes only.

An irrigation conduit 30 connects the irrigation channel 26 to a supply of water 32 such that water W is selectively expelled through the plurality of openings 28 formed through the first end 22 of the drill bit 20. Although FIG. 1 illustrates water supply 32 as being located external to the handpiece 12, it should be understood that water supply 32 may have any suitable location with respect to handpiece 12, including internal to the handpiece 12, and may also be any suitable supply of water. Water supply 32 may be a pressurized source of water, or may include, or be used in combination with, any necessary pumps or the like for supplying water W to irrigation channel 26. The water W can act to both cool the drill bit 20 and to irrigate and clean debris from the patient's mouth during drilling. In addition, since the plurality of openings 28 are located near the cutting head of the drill bit 20, the water W can cool down the bone and drill but 20 contact surface and help to prevent bone necrosis.

A suction conduit 38 connects the suction channel 34 to a vacuum source 40 such that fluid and debris are selectively collected through the plurality of apertures 36 formed through the shaft 42 of the drill bit 20 (the suction is indicated generally as S in FIG. 2). Although FIG. 1 illustrates vacuum source 40 as being located external to the handpiece 12, it should be understood that vacuum source 40 may have any suitable location with respect to handpiece 12, including internal to the handpiece 12, and may also be any suitable type of vacuum, suction device, source of negative pressure or the like. The suction S acts to remove the irrigation water W, drilling debris, and/or excess saliva from the patient's mouth during drilling.

The socket 18 and drill bit 20 are selectively driven to rotate in a conventional manner, such as by a conventional motor 44 or the like coupled to the socket 18, as is well-known in the field of dental drills. It should be understood that mechanical coupling 46 for coupling motor 44 to socket 18 is shown for exemplary purposes only, and that motor 44 may be coupled to socket 18 by any suitable means, as is well-known in the field of dental drills. Further, it should be understood that motor 44 may be replaced by any suitable type of source of rotational drive, such as pneumatic or hydraulic drives or motors, or the like.

The socket 18 and drill bit 20 can be made of any suitable material as is well known in the field of dental drills. By way of non-limiting example, the socket 18 and/or drill bit 20 can be made of stainless steel, diamond, or tungsten carbide optionally combined with cobalt or nickel.

It is to be understood that the dental drill is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A dental drill, comprising:
a handpiece having a head and a gripping portion;
a socket located within the head of the handpiece;
a drill bit having opposed first and second ends, the second end thereof being received by the socket, and the first end thereof being positioned external to the handpiece, wherein an irrigation channel is formed through the drill bit, the irrigation channel being in fluid communication with a plurality of openings formed through the first end of the drill bit;
an irrigation conduit connecting the irrigation channel to a supply of water such that the water is selectively expelled through the plurality of openings formed through the first end of the drill bit; and
means for selectively driving the socket and the drill bit to rotate,
wherein a suction channel being in fluid communication with a plurality of apertures is formed through a shaft of the drill bit, the dental drill further comprising a suction conduit connecting the suction channel to a vacuum source such that fluid and debris are selectively collected through the plurality of apertures formed through the shaft of the drill bit,
wherein the supply of water is selectively expelled through the plurality of openings formed through the first end of the drill bit and the fluid and debris are selectively collected through the plurality of apertures formed through the shaft of the drill bit simultaneously, and
wherein the selectively expelled supply of water cools the drill bit while the fluid and debris are selectively collected through the plurality of apertures.

2. The dental drill as recited in claim 1, wherein the irrigation channel is positioned along a rotational axis of the drill bit.

3. The dental drill as recited in claim 1, wherein the first end of the drill bit defines a drilling head of the drill bit.

4. The dental drill as recited in claim 3, wherein the drilling head has a conical shape terminating in a vertex.

5. (canceled)

6. A dental drill, comprising:
a handpiece having a head and a gripping portion;
a socket located within the head of the handpiece;
a drill bit having opposed first and second ends, the second end thereof being received by the socket, and the first end thereof being positioned external to the handpiece, wherein an irrigation channel is formed through the drill bit, the irrigation channel being in fluid communication with a plurality of openings formed through the first end of the drill bit, and wherein a suction channel is formed through the drill bit, the suction channel being in fluid communication with a plurality of apertures formed through a shaft of the drill bit;
an irrigation conduit connecting the irrigation channel to a supply of water such that the water is selectively expelled through the plurality of openings formed through the first end of the drill bit;
a suction conduit connecting the suction channel to a vacuum source such that fluid and debris are selectively collected through the plurality of apertures formed through the shaft of the drill bit; and
means for selectively driving the socket and the drill bit to rotate,
wherein the supply of water is selectively expelled through the plurality of openings formed through the first end of the drill bit and the fluid and debris are selectively collected through the plurality of apertures formed through the shaft of the drill bit simultaneously, and
wherein the selectively expelled supply of water cools the drill bit while the fluid and debris are selectively collected through the plurality of apertures.

7. The dental drill as recited in claim 6, wherein the irrigation channel is positioned along a rotational axis of the drill bit.

8. The dental drill as recited in claim 6, wherein the first end of the drill bit defines a drilling head of the drill bit.

9. The dental drill as recited in claim 8, wherein the drilling head has a conical shape terminating in a vertex.

10. A dental drill, comprising:
a handpiece having a head and a gripping portion;
a socket located within the head of the handpiece;
a drill bit having opposed first and second ends, the second end thereof being received by the socket, and the first end thereof being positioned external to the handpiece, wherein a suction channel is formed through the drill bit the suction channel being in fluid communication with a plurality of apertures formed through a shaft of the drill bit;
a suction conduit connecting the suction channel to a vacuum source such that fluid and debris are selectively collected from a patient's mouth through the plurality of apertures formed through the shaft of the drill bit; and
means for selectively driving the socket and the drill bit to rotate,
wherein an irrigation channel is formed through the drill bit, the irrigation channel being in fluid communication with a plurality of openings formed through the first end of the drill bit, the dental drill further comprising an irrigation conduit connecting the irrigation channel to a supply of water such that the water is selectively expelled through the plurality of openings formed through the first end of the drill bit,
wherein the supply of water is selectively expelled through the plurality of openings formed through the first end of the drill bit and the fluid and debris are selectively collected through the plurality of apertures formed through the shaft of the drill bit simultaneously, and
wherein the selectively expelled supply of water cools the drill bit while the fluid and debris are selectively collected through the plurality of apertures.

11. The dental drill as recited in claim 10, wherein the first end of the drill bit defines a drilling head of the drill bit.

12. The dental drill as recited in claim 11, wherein the drilling head has a conical shape terminating in a vertex.

13. (canceled)

14. The dental drill as recited in claim 10, wherein the irrigation channel is positioned along a rotational axis of the drill bit.
